(19) United States
(12) Patent Application Publication
(10) Pub. No.: US 2014/0136211 A1
(43) Pub. Date: May 15, 2014

(54) VOICE CONTROL ON MOBILE INFORMATION DEVICE

(71) Applicant: NVIDIA CORPORATION, Santa Clara, CA (US)

(72) Inventors: Li-Ling CHOU, New Taipei City (TW); David HO, Taipei (TW)

(73) Assignee: NVIDIA Corporation, Santa Clara, CA (US)

(21) Appl. No.: 13/847,782

(22) Filed: Mar. 20, 2013

(30) Foreign Application Priority Data
Nov. 12, 2012 (TW) 101142035

(51) Int. Cl. G10L 21/00; H04N 5/232

(52) U.S. Cl. CPC G10L 21/00; H04N 5/232
USPC 704/275

(57) ABSTRACT

A method for controlling a mobile information device based on verbal input from a user is presented. The method comprises waiting for a predetermined verbal input from a user. The method further comprises controlling a functional module of the mobile information device to determine a value within a predetermined range for a functional parameter in response to a first portion of the verbal input. Finally, the method comprises executing a functional operation by the functional module based on a determined value, in response to a second portion of the verbal input, wherein the second portion follows the first portion.

### FIELD OF THE INVENTION

The present invention relates to mobile information devices, and more particularly, to voice control on a mobile information device.

### CROSS-REFERENCES TO RELATED APPLICATIONS

This application claims priority to Taiwan Patent Application 101142035, filed on Nov. 12, 2012, hereby incorporated by reference in its entirety.

### BACKGROUND OF THE INVENTION

The concept of controlling a device through verbal input from a user is well-known. For instance, Konica Kanpai, which was developed in 1989, is known to be the first voice-controlled film camera. Another example is Galaxy SIII, a product released by Samsung Electronics recently to provide such functions as voice-controlled dialing and voice-controlled picture taking

### SUMMARY OF THE INVENTION

In one embodiment, the present invention provides voice control on mobile information devices.

Mobile information devices nowadays are becoming more robust and feature plenty of functional parameters whereby a user can adjust the way of performing a function (for example, taking pictures or playing multimedia) dynamically according to the user's preference or need. As disclosed in the prior art, touch control is exercised over functional parameter setting and function execution triggering. For example, different buttons are provided. Conventional voice control never distinguishes the aforesaid two types of control from each other or is restricted to the latter type of control. Unlike the prior art, the present invention involves controlling functional parameter setting and function execution triggering by different portions, respectively, of a verbal input provided by a user in a single instance.

The functional parameters described herein are supposed to enable a functional module (which may comprise a combination of software and hardware) to determine a hardware setting parameter or a software algorithm parameter for use in performing a specific functional operation. The functional module can perform identical functional operations by means of different functional parameter values to meet a user's needs.

In one embodiment, the present invention provides a method for controlling a mobile information device with verbal commands. The method comprises waiting for a predetermined verbal input from a user. Further, the method comprises controlling a functional module of the mobile information device to determine a value within a predetermined range for a functional parameter, in response to a first portion of the verbal input. Also, the method comprises executing a functional operation by the functional module based on the determined value, in response to a second portion of the verbal input, wherein the second portion follows the first portion.

In another embodiment, the present invention is a mobile information device, comprising a memory unit for storing a voice control application and a central processing unit electrically connected to the memory unit for executing the voice control application so as to wait for a predetermined verbal input from a user. The mobile information device also comprises a functional module electrically connected to the central processing unit, wherein the voice control application controls the functional module to determine a value within a predetermined range for a functional parameter, in response to a first portion of the verbal input, and further wherein the voice control application controls the functional module to execute a functional operation based on the determined value, in response to a second portion of the verbal input, the second portion following the first portion.

In yet another embodiment, a computer-readable storage medium having stored thereon, computer executable instructions that, if executed by a computer system cause the computer system to perform a method for controlling a mobile information device is disclosed. This method comprises waiting for a predetermined verbal input from a user. It also comprises control controlling a functional module of the mobile information device to determine a value within a predetermined range for a functional parameter in response to a first portion of the verbal input. Finally it comprises executing a functional operation by the functional module based on the determined value, in response to a second portion of the verbal input, wherein the second portion follows the first portion.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 is a block diagram of a mobile information device according to an embodiment of the present invention; and

FIG. 2 is a flowchart of a method for controlling a mobile device with verbal commands in accordance with an embodiment of the present invention.

### DETAILED DESCRIPTION OF THE EMBODIMENTS

The present invention is described below with reference to flowchart illustrations and/or block diagrams of methods, apparatus, devices, systems, and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

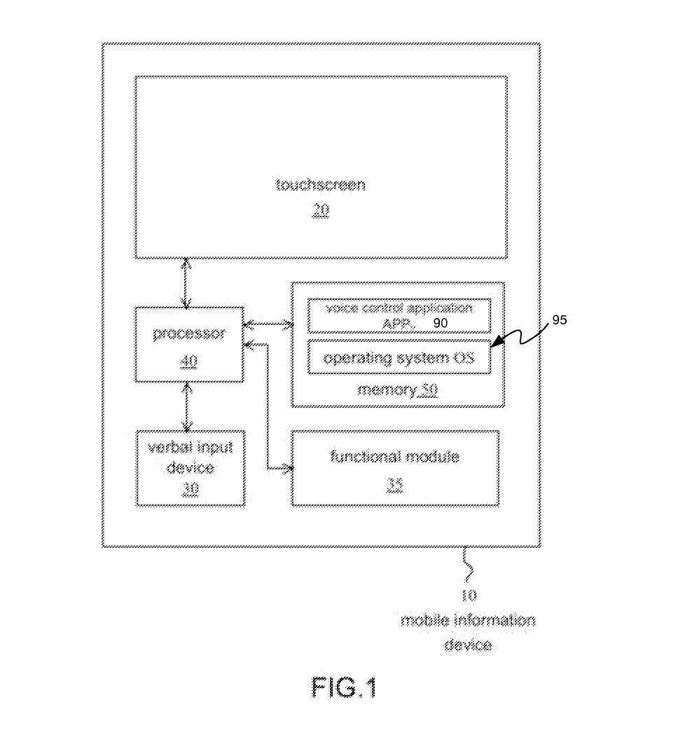

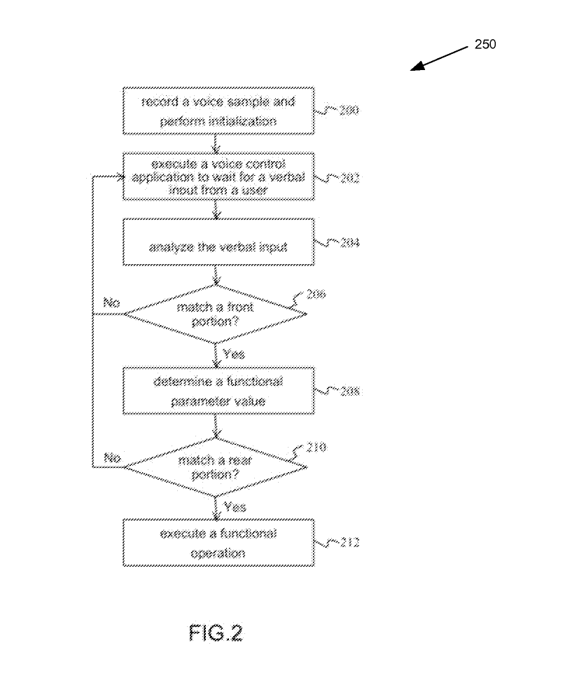

Referring now to FIG. 1 through FIG. 2, mobile information devices, methods, and computer program products are illustrated as structural or functional block diagrams or process flowcharts according to various embodiments of the present invention. The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Hardware Architecture

Referring to FIG. 1, there is shown a block diagram of the hardware architecture of a mobile information device 10 according to an embodiment of the present invention. The mobile information device 10 comprises a touchscreen 20, a verbal input device 30, a functional module 35, a processor 40, and a memory 50. Preferably, the memory 50 is a flash memory for storing a voice control application APP_{V} 90 and an operating system OS 95 of the mobile information device 10. The processor 40 accesses the memory 50 in order to execute the operating system OS 95 and the voice control application APP_{V} 90.

In one embodiment, the functional module 35 may comprise, but is not limited to, a picture-taking module or a multimedia playing module, which in turn may comprise a combination of software and hardware. Like a conventional functional module, a user can perform touch control on the functional module 35 displayed on the touchscreen 20 by means of a physical button on the mobile information device 10 or by means of a visual interface provided by a software application or the operating system OS 95. The above technical features are well-known among persons skilled in the art and thus are not reiterated herein for the sake of brevity.

In this embodiment, the voice control application APP_{V} 90 is a stand-alone application independent of the operating system OS 95, and is selectively added to the memory 50 and the operating system OS by the user. Alternatively, the user can remove the voice control application APP_{V} from the memory 50 and the operating system OS. However, in another embodiment, the voice control application APP_{V} is integrated with the operating system OS. In another aspect, if the functional module 35 includes the visual interface application or any other software application, then the functional module 35 and the voice control application APP_{V} 90 can be independent of each other or integrated with each other.

Operation Process Overflow

FIG. 2, is a flowchart of a method for controlling a mobile device with verbal commands in accordance with an embodiment of the present invention.

The invention, however, is not limited to the description provided by flowchart 250. Rather, it will be apparent to persons skilled in the relevant art(s) from the teachings provided herein that other functional flows are within the scope and spirit of the present invention. Flowchart 250 will be described with continued reference to exemplary embodiments described above, though the method is not limited to those embodiments.

At step 200, the voice control application APP_{V} 90 enables the user to record a personalized voice message that functions as a voice sample stored in the memory 50 (or a cloud storage apparatus accessible by the mobile information device 10) and performs initialization. However, the above technical features are not indispensable to the present invention. In another embodiment, a voice sample is built in the voice control application APP_{V} beforehand, and thus the user need not record any voice sample. The above technical features are well-known among persons skilled in the art and thus are not reiterated herein for the sake of brevity.

In another aspect, the voice control application APP_{V} provides a control environment, such that the user correlates voice samples with targets intended to be controlled (that is, functional parameter setting control and function execution triggering control) as shown in Table 1. The functional parameters each match a specific function, and thus the voice control application APP_{V} 90 can match a voice sample of a functional parameter with a voice sample of related function execution, so as to facilitate subsequent comparison. More related details are described below.

TABLE 1

| | functional parameter: value | |
|---|---|---|
| functional module | function execution | voice sample |
| picture-taking module | exposure: automatic | “one, two, three” |
| | static picture-taking | “cheese” |
| multimedia playing | volume: 9 | “loud” |
| module | playing music | “music” |

At step 202, the mobile device executes a voice control application to wait for a verbal input from a user. In one embodiment, the voice control application APP_{V} 90 is a daemon executed in the background. In one embodiment, if the voice control application APP_{V} is not a daemon executed in the background, the user can click on a specific icon attributed to the voice control application APP_{V} and displayed on the touchscreen 20 or can press a physical button (not shown in FIG. 1) on the mobile information device 10 so as to start the voice control application APP_{V}.

After the voice control application APP_{V} has been started, it allows the mobile information device 10 to receive input from the verbal input device 30 (such as, a microphone), thereby waiting for a verbal input sent from the user via the verbal input device 30. In one embodiment, if the mobile information device 10 comes in the form of a mobile phone, the verbal input device 30 will be the microphone used by the user while the user is having a phone conversation, thereby dispensing with any additional verbal input device.

Furthermore, if the voice control application APP_{V} is not a daemon running in the background, it will be feasible to set a waiting duration after the voice control application APP_{V} has been started. If the user does not give any verbal input during the waiting duration, the voice control application APP_{V} will shut down automatically to thereby reduce the power consumption of the mobile information device 10.

At step 204, upon receipt of a verbal input from the user, the voice control application APP_{V} analyzes the verbal input.

In an embodiment, the voice control application APPV analyzes the verbal input from the user and identifies at least two different portions of the verbal input (according to syllables or intonations, for example). Various ways of analyzing a verbal input given by a user are well-known among persons skilled in the art and thus are not defined by the present invention.

Preferably, the verbal input from the user is a phrase which comprises at least two words. The voice control application APP_{V} identifies at least two different words in the phrase (see the voice samples shown in Table 1.) Various ways of inputting and analyzing words of a phrase given by a user are well-known among persons skilled in the art and thus are not reiterated herein for the sake of brevity.

At step 206, after the voice control application APP_{V} has identified at least two different portions of the verbal input from the user, the different portions are compared with the voice sample of step 200. The voice control application APP_{V} correlates a front portion of the verbal input with the voice sample of a functional parameter. If a match is found, the voice control application APP_{V} will control the functional module 35 to determine a functional parameter value within a preset range at step 208. If no match is found, the voice control application APP_{V} will go back to step 204 to wait for the verbal input again.

As mentioned above, if a match is found, the APP_{V} will control the functional module 35 to determine a functional parameter value within a preset range at step 208. In an embodiment, the functional module 35 comes in the form of a picture-taking module for providing a static picture-taking or dynamic picture-taking function. To provide the aforesaid function, the picture-taking module 35 has to give considerations to a plurality of functional parameters, such as focal length, aperture setting, iso value, focus, picture resolution, white balance value, coding, and decoding. Taking the aperture setting as an example, the picture-taking module 35 provides an adjustment range of f/2.4 to f/4.8.

In this embodiment, the verbal input from the user is a spoken phrase “one, two, three, cheese.” If the voice control application APP_{V} determines that a front portion (i.e., “one, two, three”) of a spoken phrase matches the voice sample correlated with the diaphragm and described at step 200, the voice control application APP_{V} will control the picture-taking module 35 to determine a aperture parameter value within the range of f/2.4 to f/4.8, for example, f/3.2. In this embodiment, the voice control application APP_{V} controls the picture-taking module 35 to determine, in a predetermined manner, an appropriate aperture value (that is, by automatic determination.) Likewise, the voice control application APP_{V} can also control the picture-taking module 35 to perform automatic focusing, automatic ISO value setting, and automatic white balance. The adjective “automatic” used herein refers to a way of determining a functional parameter value, but the automatic determination performed by the picture-taking module 35 still has to be triggered and started by means of the voice control application APP_{V}.

In another embodiment, the functional module 35 comes in the form of a multimedia playing module for providing a music or animation playing function. To provide the aforesaid function, the multimedia playing module 35 has to give considerations to a plurality of functional parameters, such as volume, audio spectral distribution, and screen dimensions. Take volume as an example, the multimedia playing module 35 provides a preset adjustment range, namely from level 1 to level 10. This example, unlike the above example of the picture-taking module, is characterized in that the voice sample is, at step 200, further correlated with a specific value of a volume parameter, say, 9.

In this embodiment, the verbal input from the user is a spoken phrase “loud music”. Hence, if the voice control application APP_{V} determines that a front portion (i.e., “loud”) of the spoken phrase matches the voice sample correlated with volume value 9, the voice control application APP_{V} will control the multimedia playing module 35 to set the volume parameter value to 9 directly rather than require the picture-taking module 35 to determine a functional parameter value as described in the above example of the picture-taking module.

At step 210, after the functional module 35 has determined a functional parameter value, say, a aperture value of f/3.2 or a volume value of 9, within a predetermined range, the voice control application APP_{V} further compares the rear portion of the verbal input with the voice sample correlated with function execution and described at step 200. If a match is found, the voice control application APP_{V} will control the functional module 35 to execute a functional operation at step 212 according to the functional parameter value determined at step 208. If no match is found, the voice control application APP_{V} will go back to step 204 to wait for the verbal input from the user again.

If, at step 200, the voice control application APP_{V} has already matched the voice sample of a functional parameter with the voice sample of a corresponding function execution, the voice control application APP_{V} will quickly find the voice sample correlated with the corresponding function execution according to the voice sample correlated with the functional parameter and determined at step 208 to be a match, and then the voice control application APP_{V} will compare the found voice sample with the rear portion of the verbal input from the user. Hence, it is not necessary for the voice control application APP_{V} to compare all the voice samples, and thus the comparison process can be speeded up.

Referring to Table 1, in the embodiment where the verbal input from the user is a phrase “one, two, three, cheese.” and the functional module 35 in that particular embodiment is the picture-taking module, if the voice control application APP_{V} determines that a rear portion (i.e., “cheese”) of the verbal input matches a voice sample described at step 200 and correlated with static picture-taking, the voice control application APP_{V} will control the picture-taking module 35 to perform static picture-taking and thereby produce an image according to a aperture parameter value of f/3.2 determined at step 208.

Likewise, in the embodiment where the verbal input from the user is a phrase “loud music” and the functional module 35 comes in the form of a multimedia playing module, if the voice control application APP_{V} determines that a rear portion (i.e., “music”) of the verbal input matches a voice sample described at step 200 and correlated with playing music, the voice control application APP_{V} will control the multimedia playing module 35 to play music according to the volume parameter value of 9 determined at step 208.

In another embodiment, at step 210, the voice control application APP_{V} not only determines that a rear portion of the verbal input from the user matches a voice sample correlated with function execution, but also determines whether a rear portion (i.e., “cheese”) of the verbal input (for example, “one, two, three, cheese”) from the user is entered within a predetermined duration, say, 3 seconds, following the front portion (i.e., “one, two, three”.) If the determination is affirmative, the voice control application APP_{V} will control the functional module 35 to execute the functional operation. If the determination is negative, the process flow of the method of the present invention will go back to step 204 to wait for the verbal input again.

The foregoing preferred embodiments are provided to illustrate and disclose the technical features of the present invention, and are not intended to be restrictive of the scope of the present invention. Hence, all equivalent variations or modifications made to the foregoing embodiments without departing from the spirit embodied in the disclosure of the present invention should fall within the scope of the present invention as set forth in the appended claims.

What is claimed is:

1. A mobile information device, comprising:
a memory unit for storing a voice control application;
a processor electrically coupled to the memory unit, wherein the processor is configured to execute a voice control application; and
a functional module electrically connected to the processor,
wherein the voice control application is operable to:
wait for a predetermined audible input from a user;
control the functional module to determine a value within a predetermined range for a functional parameter in response to a first portion of the audible input; and
control the functional module to execute a functional operation based on a determined value in response to a second portion of the audible input, wherein the second portion of the audible input temporally follows the first portion.

2. The mobile information device of claim 1, wherein the functional module determines the value based on the first portion.

3. The mobile information device of claim 1, wherein the audible input is a phrase, the first portion comprises at least a first word, and the second portion comprises at least a second word.

4. The mobile information device of claim 1, wherein the voice control application is included in or removed from the memory unit selectively by the user.

5. The mobile information device of claim 1, wherein the functional module is a camera module, the functional parameter is a camera parameter, and the functional operation is a camera operation.

6. The mobile information device of claim 5, wherein the camera parameter is an aperture setting of the picture-taking module.

7. The mobile information device of claim 1, wherein the functional module is a multimedia playing module, the functional parameter is a playing parameter, and the functional operation is a multimedia playing operation.

8. The mobile information device of claim 7, wherein the playing parameter is a volume of the multimedia playing module.

9. The mobile information device of claim 1, wherein the functional parameter is a hardware setting parameter.

10. A method for controlling a mobile information device, said method comprising:
waiting for a predetermined verbal input from a user;
controlling a functional module of the mobile information device to determine a value within a predetermined range for a functional parameter in response to a first portion of the verbal input; and
executing a functional operation by the functional module based on a determined value, in response to a second portion of the verbal input, wherein the second portion temporally follows the first portion.

11. The method of claim 10, wherein the verbal input is a phrase, the first portion comprises at least a first word, and the second portion comprises at least a second word.

12. The method of claim 10, wherein the verbal input is a phrase, the first portion comprises at least a first word, and the second portion comprises at least a second word.

13. The method of claim 10, wherein the voice control application is included in or removed from the memory unit selectively by the user.

14. The method of claim 10, wherein the functional module is a camera module, the functional parameter is a camera parameter, and the functional operation is a camera operation.

15. The method of claim 14, wherein the camera parameter is an aperture setting of the picture-taking module.

16. The method of claim 10, wherein the functional module is a multimedia playing module, the functional parameter is a playing parameter, and the functional operation is a multimedia playing operation.

17. The method of claim 16, wherein the playing parameter is a volume of the multimedia playing module.

18. The method of claim 1, wherein the functional parameter is a hardware setting parameter.

19. A computer-readable storage medium having stored thereon, computer executable instructions that, if executed by a computer system cause the computer system to perform a method for controlling a mobile information device, said method comprising:
waiting for a predetermined verbal input from a user;
controlling a functional module of the mobile information device to determine a value within a predetermined range for a functional parameter in response to a first portion of the verbal input; and
executing a functional operation by the functional module based on a determined value, in response to a second portion of the verbal input, wherein the second portion temporally follows the first portion.

20. The computer readable medium as described in claim 19, wherein the functional module determines the value based on the first portion.
